(19) United States
(12) Patent Application Publication
(10) Pub. No.: US 2018/0188880 A1
(43) Pub. Date: Jul. 5, 2018

(54) TOUCH SUBSTRATE AND TOUCH DISPLAY DEVICE

(71) Applicant: BOE TECHNOLOGY GROUP CO., LTD., Beijing (CN)

(72) Inventors: Mingxi WANG, Beijing (CN); Zhilei WU, Beijing (CN); Shiming SHI, Beijing (CN)

(73) Assignee: BOE TECHNOLOGY GROUP CO., LTD., Beijing (CN)

(21) Appl. No.: 15/705,852

(22) Filed: Sep. 15, 2017

(30) Foreign Application Priority Data
Jan. 3, 2017 (CN) 201710001386.1

(51) Int. Cl. G06F 3/041; G06F 3/044

(52) U.S. Cl. CPC G06F 3/0416; G06F 3/044

(57) ABSTRACT

A touch substrate and a touch display device are provided. The touch substrate includes: a touch region and a wiring region, a plurality of touch electrodes is arranged at the touch region, and a Gate Driver on Array (GOA) circuit, input signal wires and electrode input wires are arranged at the wiring region; input ends of the GOA circuit are connected to a touch integrated circuit via the input signal wires, to receive via the input signal wires touch signals and time sequence signals sent by the touch integrated circuit; and output ends of the GOA circuit are connected to input ends of the touch electrodes respectively via the electrode input wires, to output in sequence, to the touch electrodes respectively, output signals corresponding to respective touch electrodes via the electrode input wires.

### CROSS-REFERENCE TO RELATED APPLICATION

This application claims priority to Chinese Patent Application No. 201710001386.1 filed Jan. 3, 2017, which is incorporated herein by reference in its entirety.

### TECHNICAL FIELD

The present disclosure relates to the field of touch control technology, and in particularly to a touch substrate and a touch display device.

### BACKGROUND

In the related art, a touch substrate has a touch region and a wiring region. A plurality of first touch electrodes and second touch electrodes crossing each other are arranged at the touch region, and a plurality of first electrode input wires and second electrode input wires are arranged at the wiring region. Each touch electrode is connected to a Flexible Printed Circuit (FPC) via a relatively long electrode input wire, and the electrode input wires occupy a large area of the wiring region. In addition, the FPC needs to have a plurality of pins which are connected to the electrode input wires respectively, so the FPC pins also needs to be arranged on the touch substrate. Therefore, the above arrangement is not good for achieving a narrow bezel.

### SUMMARY

In view of this, a touch substrate and a touch display device are provided in the present disclosure, so as to solve the above technical issues in the related art.

To achieve the above objective, a touch substrate is provided in at least one embodiment of the present disclosure, including a touch region and a wiring region, where a plurality of touch electrodes is arranged at the touch region, and a Gate Driver on Array (GOA) circuit, input signal wires and electrode input wires are arranged at the wiring region; input ends of the GOA circuit are connected to a touch integrated circuit via the input signal wires, to receive via the input signal wires touch signals and time sequence signals sent by the touch integrated circuit; and output ends of the GOA circuit are connected to input ends of the touch electrodes respectively via the electrode input wires, to output in sequence, to the touch electrodes respectively, output signals corresponding to respective touch electrodes via the electrode input wires.

Optionally, a quantity of the input signal wires is smaller than a quantity of the electrode input wires.

Optionally, the input signal wires include a TP signal wire, a STV signal wire, a clock signal wire and a level signal wire.

Optionally, the clock signal wire includes a first clock signal wire and a second clock signal wire, and the level signal wire includes a high-level signal wire and a low-level signal wire.

Optionally, the touch electrodes include touch driving electrodes and/or touch sensing electrodes.

Optionally, the touch electrodes include the touch driving electrodes and the touch sensing electrodes, and the GOA circuit includes a first GOA circuit connected to the touch driving electrodes and a second GOA circuit connected to the touch sensing electrodes.

Optionally, electrode output wires are arranged at the wiring region, and two ends of each electrode output wire are respectively connected to the touch integrated circuit and output ends of the touch electrodes.

Optionally, the touch electrodes include the touch driving electrodes and the touch sensing electrodes, and the touch driving electrodes and the touch sensing electrodes are connected to different electrode output wires.

Optionally, the input signal wires include first input signal wires and second input signal wires, and the electrode input wires include first electrode input wires and second electrode input wires; the first GOA circuit is connected to the touch integrated circuit via the first input signal wires, and the second GOA circuit is connected to the touch integrated circuit via the second input signal wires; and the first GOA circuit is connected to input ends of the touch driving electrodes via the first electrode input wires, and the second GOA circuit is connected to input ends of the touch sensing electrodes via the second electrode input wires.

Optionally, first electrode output wires and second electrode output wires are arranged at the wiring region; two ends of each first electrode output wire are respectively connected to the touch integrated circuit and output ends of the touch driving electrodes; and two ends of each second electrode output wire are respectively connected to the touch integrated circuit and output ends of the touch sensing electrodes.

Optionally, a quantity of the first input signal wires is smaller than a quantity of the first electrode input wires, and a quantity of the second input signal wires is smaller than a quantity of the second electrode input wires.

Optionally, a touch display device including the above touch substrate is further provided in at least one embodiment of the present disclosure.

Optionally, the touch display device further includes a Flexible Printed Circuit (FPC) provided with a touch integrated circuit, where a quantity of touch signal output pins of the FPC is identical to a quantity of the input signal wires.

### BRIEF DESCRIPTION OF THE DRAWINGS

FIG. 1 is a schematic view of a touch substrate in the related art;

FIG. 2 is a schematic view of a touch substrate in at least one embodiment of the present disclosure;

FIG. 3 is a schematic view of a touch substrate in at least one embodiment of the present disclosure;

FIG. 4 is a schematic view of a touch substrate in at least one embodiment of the present disclosure; and

FIG. 5 shows a working principle of a GOA circuit in at least one embodiment of the present disclosure.

### DETAILED DESCRIPTION

In order to make the objects, the features and the advantages of the present disclosure more apparent, embodiments of the technical solutions provided by the present disclosure will be described hereinafter in a clear and complete manner in conjunction with the drawings. Obviously, the following embodiments are merely a part of, rather than all of, the embodiments of the present disclosure, and based on these embodiments, a person skilled in the art may obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “connect” or “connected to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

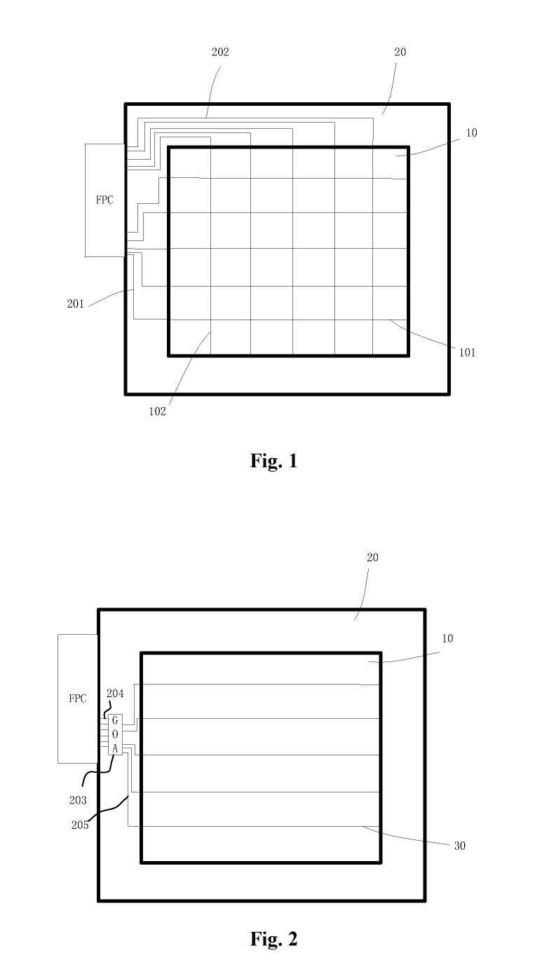

Referring to FIG. 1 which is a schematic view of a touch substrate in the related art, a touch substrate has a touch region 10 and a wiring region 20. A plurality of first touch electrodes 101 and second touch electrodes 102 crossing each other are arranged at the touch region 10, and a plurality of first electrode input wires 201 and second electrode input wires 202 are arranged at the wiring region 20. Each first touch electrode 101 is connected to a Touch IC of a FPC via the first electrode input wire 201, so as to receive a first touch signal sent by the Touch IC. Each second touch electrode 102 is connected to the Touch IC of the FPC via the second electrode input wire 202, so as to receive a second touch signal sent by the Touch IC. Only five first touch electrodes 101 and five second touch electrodes 102 at the touch region 10 are shown in FIG. 1, however there are more touch electrodes actually.

It can be seen from FIG. 1 that, each touch electrode is connected to the FPC via a relatively long electrode input wire, and the electrode input wires occupy a large area of the wiring region. In addition, the FPC needs to have a plurality of circuit pins which are connected to the electrode input wires respectively, so the FPC pins also needs to be arranged on the touch substrate. Therefore, the above arrangement is not good for achieving a narrow bezel.

Referring to FIG. 2 which is a schematic view of a touch substrate in at least one embodiment of the present disclosure. In at least one embodiment of the present disclosure, the touch substrate includes a touch region 10 and a wiring region 20. A plurality of touch electrodes 30 is arranged at the touch region 10, and a GOA circuit 203, input signal wires 204 and electrode input wires 205 are arranged at the wiring region 20. A quantity of the electrode input wires 205 is identical to a quantity of the touch electrodes 30. Input ends of the GOA circuit 203 are connected to a touch integrated circuit (the FPC having the touch integrated circuit shown in FIG. 2) via the input signal wires 204, to receive touch signals and time sequence signals sent by the touch integrated circuit. Output ends of the GOA circuit 203 are connected to input ends of the touch electrodes 30 respectively via the electrode input wires 205, to output in sequence, to the touch electrodes 30 respectively, output signals corresponding to respective touch electrodes 30.

In at least one embodiment of the present disclosure, the signals sent by the touch integrated circuit to the GOA circuit 203 includes the touch signals and time sequence signals, the GOA circuit 203 is able to convert the touch signals, based on the time sequence signals, into output signals corresponding to respective touch electrodes 30 and send the output signals to the touch electrodes 30 in sequence. Therefore, it does not require many input signal wires to transmit the touch signals and time sequence signals.

According to the touch substrate in at least one embodiment of the present disclosure, the GOA circuit 203 is arranged at the wiring region 10, the input ends of the GOA circuit 203 are connected to the touch integrated circuit via a small amount of input signal wires 204, and the output ends of the GOA circuit 203 are respectively connected to the input ends of the touch electrodes 30 via relatively short electrode input wires 205. Therefore, it is not required to connect the touch electrodes 30 to the touch integrated circuit via relatively long wires, and the area occupied by the wiring region 20 may be reduced. In addition, a quantity of circuit pins of the FPC having the touch integrated circuit may be identical to a quantity of the input signal wires 204. In compare with the related art, the quantity of the circuit pins may be reduced significantly, thereby further reducing the area occupied by the wiring region 20 and reducing the production cost of the FPC.

In at least one embodiment of the present disclosure, a quantity of the input signal wires 204 is smaller than a quantity of the electrode input wires 205.

In at least one embodiment of the present disclosure, the input signal wires 204 may include a TP signal (data source row latched signal) wire, a STV signal (frame start signal) wire, a clock signal wire and a level signal wire.

In at least one embodiment of the present disclosure, there are six input signal wires 204, including a TP signal wire, a STV signal wire, a first clock signal wire (CK), a second clock signal wire (CKB), a high-level signal wire (VGH) and a low-level signal wire (VGL).

The working principle of the GOA circuit in at least one embodiment of the present disclosure is the same as that of the GOA circuit in the related art. Referring to FIG. 5, the GOA circuit is able to convert the single pulse signals sent by the touch integrated circuit, based on the corresponding time sequence signals (e.g., STU, CLKA and CLKB), into output signals G(1), G(2), G(3), G(4) corresponding to respective touch electrodes, and send the output signals to respective touch electrodes, the detailed description thereof may be omitted herein.

In at least one embodiment of the present disclosure, the touch substrate may be a self-capacitance touch substrate or a mutual-capacitance touch substrate. In the case that the touch substrate is a self-capacitance touch substrate, the touch electrodes in at least one embodiment of the present disclosure may be self-capacitance electrodes. In the case that the touch substrate is a mutual-capacitance touch substrate, the touch electrodes in at least one embodiment of the present disclosure may be mutual-capacitance electrodes.

In the case that the touch substrate is a mutual-capacitance touch substrate, the touch substrate includes touch driving electrodes and touch sensing electrodes crossing each other. In at least one embodiment of the present disclosure, the touch electrodes may be touch driving electrodes connected to the touch integrated circuit via the GOA circuit. In at least one embodiment of the present disclosure, the touch electrodes may be touch sensing electrodes connected to the touch integrated circuit via the GOA circuit. Of course, in at least one embodiment of the present disclosure, the touch electrodes may be both the touch driving electrodes and touch sensing electrodes connected to the touch integrated circuit via the GOA circuit.

Optionally, the GOA circuit includes a first GOA circuit connected to the touch driving electrodes and a second GOA circuit connected to the touch sensing electrodes.

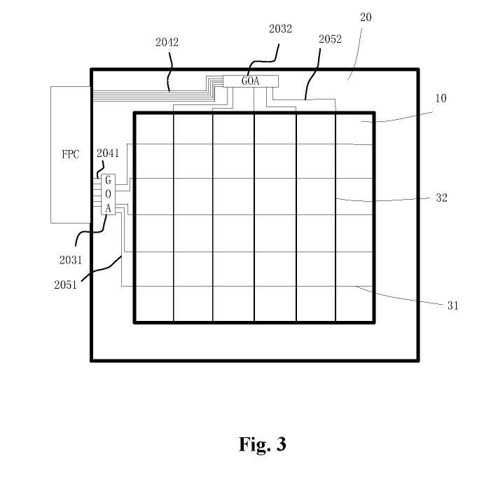

Referring to FIG. 3 which is a schematic view of a touch substrate in at least one embodiment of the present disclosure. In at least one embodiment of the present disclosure, the touch substrate includes a touch region 10 and a wiring region 20. A plurality of first touch electrodes 31 and second touch electrodes 32 are arranged at the touch region 10. A first GOA circuit 2031 corresponding to the first touch electrodes 31, first input signal wires 2041 and first electrode input wires 2051 are arranged at the wiring region 20. A quantity of the first electrode input wires 2051 is identical to a quantity of the first touch electrodes 31. Input ends of the first GOA circuit 2031 are connected to the touch integrated circuit (the FPC having the touch integrated circuit shown in FIG. 3) via the first input signal wires 2041, to receive touch signals and time sequence signals sent by the touch integrated circuit. Output ends of the first GOA circuit 2031 are connected to input ends of the first touch electrodes 31 respectively via the first electrode input wires 2051, to output in sequence, to the first touch electrodes 31 respectively, output signals corresponding to respective first touch electrodes 31. A second GOA circuit 2032 corresponding to the second touch electrodes 32, second input signal wires 2042 and second electrode input wires 2052 are also arranged at the wiring region 20. A quantity of the second electrode input wires 2052 is identical to a quantity of the second touch electrodes 32. Input ends of the second GOA circuit 2032 are connected to the touch integrated circuit (the FPC having the touch integrated circuit shown in FIG. 3) via the second input signal wires 2042, to receive touch signals and time sequence signals sent by the touch integrated circuit. Output ends of the second GOA circuit 2032 are connected to input ends of the second touch electrodes 32 respectively via the second electrode input wires 2052, to output in sequence, to the second touch electrodes 32 respectively, output signals corresponding to respective second touch electrodes 32.

The first touch electrodes 31 may be TX electrodes and the second touch electrodes 32 may be RX electrodes, or first touch electrodes 31 may be RX electrodes and the second touch electrodes 32 may be TX electrodes.

According to the touch substrate in at least one embodiment of the present disclosure, the GOA circuit (the first GOA circuit 2031 and the second GOA circuit 2032) is arranged at the wiring region 10, the input ends of the GOA circuit are connected to the touch integrated circuit via a small amount of input signal wires (the first input signal wires and the second input signal wires), and the output ends of the GOA circuit are respectively connected to the input ends of the touch electrodes (the first touch electrodes and the second touch electrodes) via relatively short electrode input wires. Therefore, it is not required to connect the touch electrodes to the touch integrated circuit via relatively long wires, and the area occupied by the wiring region 20 may be reduced. In addition, a quantity of circuit pins of the FPC having the touch integrated circuit may be identical to a quantity of the input signal wires 204. In compare with the related art, the quantity of the circuit pins may be reduced significantly, thereby further reducing the area occupied by the wiring region 20 and reducing the production cost of the FPC.

In order to determine the touch position, the touch electrodes serving as the touch sensing electrodes need to send back the sensing signals to the touch integrated circuit, and then the touch integrated circuit may determine the touch position. In at least one embodiment of the present disclosure, the touch substrate may further include an electrode output wire arranged at the wiring region, and two ends of each electrode output wire are respectively connected to the touch integrated circuit and output ends of the touch electrodes, so the touch integrated circuit may determine which touch electrode has been touched based on time sequence corresponding to the signals of the touch electrodes.

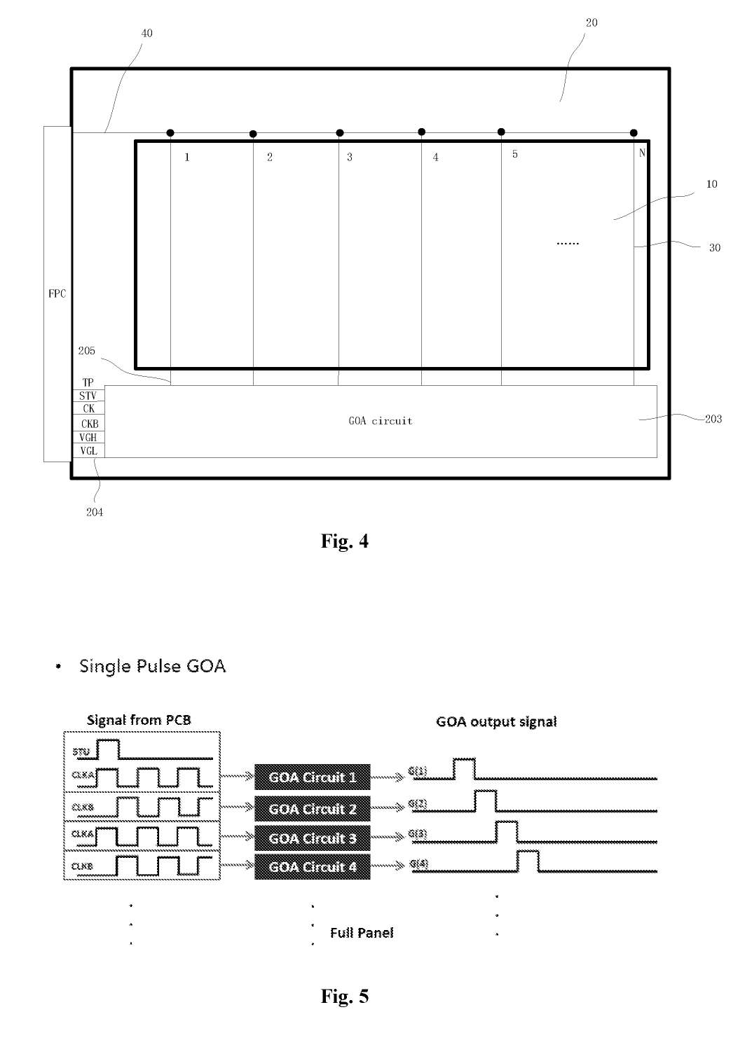

Referring to FIG. 4 which is a schematic view of a touch substrate in at least one embodiment of the present disclosure, the touch substrate includes a touch region 10 and a wiring region 20. A plurality of touch electrodes 30 is arranged at the touch region 10, and a GOA circuit 203, input signal wires 204 and electrode input wires 205 are arranged at the wiring region 20. A quantity of the electrode input wires 205 is identical to a quantity of the touch electrodes 30. Input ends of the GOA circuit 203 are connected to a touch integrated circuit (the FPC having the touch integrated circuit shown in FIG. 2) via the input signal wires 204, to receive touch signals and time sequence signals sent by the touch integrated circuit. Output ends of the GOA circuit 203 are connected to input ends of the touch electrodes 30 respectively via the electrode input wires 205, to output in sequence, to the touch electrodes 30 respectively, output signals corresponding to respective touch electrodes 30. The touch substrate further includes an electrode output wire 40 arranged at the wiring region 20, and two ends of each electrode output wire 40 are respectively connected to the touch integrated circuit and output ends of the touch electrodes 30.

There are six input signal wires 204, including a TP signal wire, a STV signal wire, a first clock signal wire (CK), a second clock signal wire (CKB), a high-level signal wire (VGH) and a low-level signal wire (VGL). A quantity of the input signal wires 204 is much smaller than a quantity of the electrode input wires 205.

According to the touch substrate in at least one embodiment of the present disclosure, the output ends of the touch electrodes are connected to the touch integrated circuit via only one electrode output wire, thereby reducing the occupied area of the wiring region, and such arrangement is good for achieving the narrow bezel.

Optionally, the touch electrodes include the touch driving electrodes and the touch sensing electrodes, and the touch driving electrodes and the touch sensing electrodes are connected to different electrode output wires.

Optionally, the electrode output wires include first electrode output wires and second electrode output wires. Two ends of each first electrode output wire are respectively connected to the touch integrated circuit and output ends of the touch driving electrodes. Two ends of each second electrode output wire are respectively connected to the touch integrated circuit and output ends of the touch sensing electrodes.

Optionally, a quantity of the first input signal wires is smaller than a quantity of the first electrode input wires, and a quantity of the second input signal wires is smaller than a quantity of the second electrode input wires.

Based on the same principle, a touch display device including the above touch substrate is further provided in at least one embodiment of the present disclosure.

Moreover, the touch display device in at least one embodiment of the present disclosure may further include a FPC having a touch integrated circuit, and a quantity of touch signal output pins of the FPC is identical to a quantity of the input signal wires.

In at least one embodiment of the present disclosure, the touch display device may be a flexible touch display device.

The touch display device in at least one embodiment of the present disclosure may have a narrow bezel, so the touch display device may be applicable to a mobile device.

According to the touch display device in at least one embodiment of the present disclosure, the GOA circuit is arranged at the wiring region, the input ends of the GOA circuit are connected to the touch integrated circuit via a small amount of input signal wires, and the output ends of the GOA circuit are respectively connected to the input ends of the touch electrodes via relatively short electrode input wires. Therefore, it is not required to connect via relatively long wires the touch electrodes to the touch integrated circuit, and the area occupied by the wiring region may be reduced. In addition, a quantity of circuit pins of the FPC having the touch integrated circuit may be identical to a quantity of the input signal wires. In compare with the related art, the quantity of the circuit pins may be reduced significantly, thereby further reducing the area occupied by the wiring region and reducing the production cost of the FPC.

The above are merely some embodiments of the present disclosure. A person skilled in the art may make further modifications and improvements without departing from the principle of the present disclosure, and these modifications and improvements shall also fall within the scope of the present disclosure.

What is claimed is:

1. A touch substrate, comprising a touch region and a wiring region, wherein a plurality of touch electrodes is arranged at the touch region, and a Gate Driver on Array (GOA) circuit, input signal wires and electrode input wires are arranged at the wiring region;
input ends of the GOA circuit are connected to a touch integrated circuit via the input signal wires, to receive via the input signal wires touch signals and time sequence signals sent by the touch integrated circuit; and
output ends of the GOA circuit are connected to input ends of the touch electrodes respectively via the electrode input wires, to output in sequence, to the touch electrodes respectively, output signals corresponding to respective touch electrodes via the electrode input wires.

2. The touch substrate according to claim 1, wherein a quantity of the input signal wires is smaller than a quantity of the electrode input wires.

3. The touch substrate according to claim 1, wherein the input signal wires comprise a TP signal wire, a STV signal wire, a clock signal wire and a level signal wire.

4. The touch substrate according to claim 3, wherein the clock signal wire comprises a first clock signal wire and a second clock signal wire, and the level signal wire comprises a high-level signal wire and a low-level signal wire.

5. The touch substrate according to claim 1, wherein the touch electrodes comprise touch driving electrodes and/or touch sensing electrodes.

6. The touch substrate according to claim 5, wherein the touch electrodes comprise the touch driving electrodes and the touch sensing electrodes, and the GOA circuit comprises a first GOA circuit connected to the touch driving electrodes and a second GOA circuit connected to the touch sensing electrodes.

7. The touch substrate according to claim 1, wherein electrode output wires are arranged at the wiring region, and two ends of each electrode output wire are respectively connected to the touch integrated circuit and output ends of the touch electrodes.

8. The touch substrate according to claim 7, wherein the touch electrodes comprise the touch driving electrodes and the touch sensing electrodes, and the touch driving electrodes and the touch sensing electrodes are connected to different electrode output wires.

9. The touch substrate according to claim 6, wherein the input signal wires comprise first input signal wires and second input signal wires, and the electrode input wires comprise first electrode input wires and second electrode input wires;
the first GOA circuit is connected to the touch integrated circuit via the first input signal wires, and the second GOA circuit is connected to the touch integrated circuit via the second input signal wires; and
the first GOA circuit is connected to input ends of the touch driving electrodes via the first electrode input wires, and the second GOA circuit is connected to input ends of the touch sensing electrodes via the second electrode input wires.

10. The touch substrate according to claim 9, wherein first electrode output wires and second electrode output wires are arranged at the wiring region;
two ends of each first electrode output wire are respectively connected to the touch integrated circuit and output ends of the touch driving electrodes; and
two ends of each second electrode output wire are respectively connected to the touch integrated circuit and output ends of the touch sensing electrode.

11. The touch substrate according to claim 10, wherein a quantity of the first input signal wires is smaller than a quantity of the first electrode input wires, and a quantity of the second input signal wires is smaller than a quantity of the second electrode input wires.

12. The touch substrate according to claim 2, wherein electrode output wires are arranged at the wiring region, and two ends of each electrode output wire are respectively connected to the touch integrated circuit and output ends of the touch electrodes.

13. The touch substrate according to claim 3, wherein electrode output wires are arranged at the wiring region, and two ends of each electrode output wire are respectively connected to the touch integrated circuit and output ends of the touch electrodes.

14. The touch substrate according to claim 4, wherein electrode output wires are arranged at the wiring region, and two ends of each electrode output wire are respectively connected to the touch integrated circuit and output ends of the touch electrodes.

15. A touch display device comprising the touch substrate according to claim 1.

16. The touch display device according to claim 15, further comprising a Flexible Printed Circuit (FPC) provided with a touch integrated circuit, wherein a quantity of touch signal output pins of the FPC is identical to a quantity of the input signal wires.
